(19) United States
(12) Patent Application Publication
(10) Pub. No.: US 2009/0315456 A1
(43) Pub. Date: Dec. 24, 2009

(54) Flexible organic EL display and method of manufacturing the same

(75) Inventors: Tadahiro Furukawa, Tokyo (JP); Masayuki Hosoi, Tokyo (JP); Shizuo Tokito, Tokyo (JP); Toshihiro Yamamoto, Tokyo (JP); Yoshiki Nakajima, Tokyo (JP); Yoshihide Fujisaki, Tokyo (JP); Tatsuya Takei, Tokyo (JP)

Correspondence Address: BACON & THOMAS, PLLC, 625 SLATERS LANE, FOURTH FLOOR, ALEXANDRIA, VA, 22314-1176, US

(73) Assignees: KYODO PRINTING CO., LTD., Tokyo (JP); NIPPON HOSO KYOKAI, Tokyo (JP)

(21) Appl. No.: 12/457,818

(22) Filed: Jun. 23, 2009

(30) Foreign Application Priority Data
Jun. 24, 2008 (JP) 2008-164381

(51) Int. Cl. H01J 63/04; H01J 9/00

(52) U.S. Cl. 313/504; 445/24

(57) ABSTRACT

A flexible organic EL display of the present invention includes a plastic film, an adhesive layer and a lower insulating layer formed thereon, an organic EL element embedded in the lower insulating layer and constructed by forming a cathode, an organic EL layer, and an anode sequentially from a bottom, an upper insulating layer formed on the organic EL element, a TFT embedded in the upper insulating layer and constructed by forming an organic active layer, a source electrode and a drain electrode, a gate insulating layer, and a gate electrode sequentially from a bottom, and a via hole provided in the upper insulating layer and reaching the drain electrode of the TFT, wherein the anode is connected electrically to the drain electrode of the TFT via the via hole.

### CROSS-REFERENCE TO RELATED APPLICATIONS

This application is based on and claims priority of Japanese Patent Application No. 2008-164381 filed on Jun. 24, 2008, the entire contents of which are incorporated herein by reference.

### BACKGROUND OF THE INVENTION

1. Field of the Invention

The present invention relates to a flexible organic EL display employing a plastic film as a substrate and a method of manufacturing the same.

2. Description of the Related Art

An organic EL (Electroluminescence) display is expanding rapidly its applications into an information equipment, and the like. Recently the flexible display employing a plastic film as a substrate attracts attention. Such flexible display can be utilized not only for the ultra-slim and lightweight mobile display, which can be rounded and housed and is convenient for carrying, but also for the large display.

However, the plastic film possesses weak stiffness and has a low heat distortion temperature. Therefore, heat distortion such as warp, expansion/contraction, or the like easily occurs in the manufacturing step accompanied by heat treatment. For this reason, in the manufacturing method of forming various elements directly on the plastic film, the conditions of the manufacturing step accompanied by heat treatment, etc. are restricted, and high-precision alignment becomes difficult. As a result, in some cases the element substrate having desired characteristics can not be manufactured.

In order to avoid such problem, there is the method of manufacturing the element substrate for the liquid crystal display device by aligning the amorphous silicon TFT element, the color filter, etc. on the heat resistant and stiff glass substrate with high precision under the unlimited manufacturing conditions, thereby to constitute the transfer layer, and then transferring the transfer layer onto the plastic film (Patent Literature 1 (Patent Application Publication (KOKAI) 2001-356370)).

Also, the flexible display needs the flexible TFT element that can follow the bending. It is feared that the amorphous silicon TFT or the low-temperature polysilicon TFT as the driving transistor in the prior art cannot obtain satisfactory reliability. Therefore, as the driving transistor for the flexible display, the organic TFT employing the flexible organic semiconductor that can follow the bending as the active layer attracts attention.

In Patent Literature 2 (Patent Application Publication (KOKAI) 2003-255857), it is set forth that the organic EL display is manufactured by forming sequentially the gate electrode, the gate insulating film, the organic semiconductor layer, and source/drain electrodes on the plastic substrate, or the like, and then forming the organic EL element on the anode which is connected to the drain electrode.

Also, in Patent Literature 3 (Patent Application Publication (KOKAI) 2003-298067), it is set forth that, the semiconductor layer is formed of the polymer inclusion complex that does not need the high-temperature process, thereby the organic EL element can be formed easily not only on the glass substrate but also on the plastic substrate.

Meanwhile, the organic semiconductor layer and the organic EL layer have such a problem that performance is degraded by the photolithography or etching step accompanied by the process using organic solvent, water, plasma, electron beam, heat treatment, or the like, and in turn these layers hardly function.

In the above Patent Literature 2, it is feared that, since the source/drain electrodes, and the like must be patterned after the organic semiconductor layer is formed, the degradation in performance of the organic semiconductor layer caused by the photolithography step becomes a problem.

In this manner, the method of manufacturing the flexible organic EL display employing the plastic film as the substrate has not been sufficiently established. A method of forming stably the desired organic TFT and the desired organic EL element on the plastic film with high yield is earnestly demanded.

### SUMMARY OF THE INVENTION

It is an object of the present invention to provide a flexible organic EL display in which a desired organic TFT and an organic EL element are formed stably on a plastic film with high yield, and a method of manufacturing the same.

The present invention is concerned with a flexible organic EL display of active matrix type in which a TFT and an organic EL element are provided in every pixel, which includes a plastic film; an adhesive layer formed on the plastic film; a lower insulating layer formed on the adhesive layer; the organic EL element embedded in the lower insulating layer and constructed by forming a cathode, an organic EL layer, and an anode sequentially from a bottom; an upper insulating layer formed on the organic EL element; the TFT embedded in the upper insulating layer, and constructed by forming an organic active layer, a source electrode and a drain electrode, a gate insulating layer, and a gate electrode sequentially from a bottom; and a via hole provided in the upper insulating layer and reaching the drain electrode of the TFT; wherein the anode is connected electrically to the drain electrode of the TFT via the via hole.

The flexible organic EL display of the present invention is manufactured in such a way that the transfer layer including the TFT, the insulating layer for coating the TFT, the organic EL element, and the insulating layer for coating the element is formed in a peelable state on the temporary substrate (the glass substrate, or the like), and then the transfer layer is transferred/formed on the plastic film via the adhesive layer in a state that the top and bottom reverses. Therefore, the TFT and the organic EL element are transferred onto the plastic film in a state that the top and bottom reverses from the structure that is formed on the temporary substrate.

By this matter, the TFT is composed of the organic active layer, the source electrode and the drain electrode, the gate insulating layer, and the gate electrode sequentially from the bottom, and is embedded in the upper insulating layer. Also the organic EL element is composed of the cathode, the organic EL layer, and the anode sequentially from a bottom, and is embedded in the lower insulating layer.

Then, the via hole reaching the drain electrode of the TFT is provided in the upper insulating layer in which the TFT is embedded, and the anode is connected electrically to the drain electrode of the TFT via the via hole.

In the present invention, since such transfer technology is employed, the organic EL element is formed under the TFT such that this element is protected by the lower insulating layer and the upper insulating layer and is embedded therein. As a result, such a situation can be prevented that steam from an outside air and moisture in the plastic film enter into the organic EL element, and thus reliability of the organic EL element can be improved.

Also, in the preferred mode of the present invention, a buffer layer made of an inorganic insulating layer is provided on the TFT, and an organic active layer of the TFT is arranged between the buffer layer and the upper insulating layer. As a result, such a situation can be prevented that steam from an outside air and moisture in the plastic film enter into the organic active layer, and thus reliability of the organic TFT can be improved.

Also, in the preferred mode of the present invention, the gate insulating layer of the TFT is formed of an insulating layer which contains no hydroxyl group and is obtained by polymerizing/cross-linking poly vinyl phenol, poly methyl silsesquioxane, or polyimide by applying a heat treatment (anneal). In the present invention, since the transfer technology is utilized, the insulating layer containing no hydroxyl group can be formed by heat-treating the coating film such as poly vinyl phenol, or the like at a temperature of 180° C. or more on the heat-resistant temporary substrate, in the formation of the gate insulating layer. Therefore, the gate insulating layer which has a sufficient dielectric breakdown electric field strength (1 MV/cm or more) and can follow a bending stress can be transferred/formed on the plastic film easily.

Also, the present invention is concerned with a method of manufacturing a flexible organic EL display of active matrix type in which a TFT and an organic EL element are provided in every pixel, which includes the steps forming a transparent peelable layer on a temporary substrate; forming the TFT constructed by forming a gate electrode, a gate insulating layer, a source electrode and a drain electrode, and an organic active layer over the transparent peelable layer sequentially from a bottom; forming a first insulating layer on the TFT; forming a via hole reaching the drain electrode of the TFT, by processing the first insulating layer; forming the organic EL element composed of an anode connected to the drain electrode via the via hole, an organic EL layer formed on the anode, and a cathode formed on the organic EL layer, on the first insulating layer; forming a second insulating layer on the organic EL element; adhering a plastic film onto the second insulating layer via an adhesive layer; and transferring/forming the second insulating layer, the organic EL element, the first insulating layer, the TFT, and the transparent peelable layer onto the plastic film via the adhesive layer, by peeling the temporary substrate along a boundary between the temporary substrate and the transparent peelable layer.

By using the manufacturing method of the present invention, the foregoing flexible organic EL display of the present invention can be manufactured easily.

In the present invention, the transparent peelable layer is used as the separating layer at a time of the transfer operation. Thus, the transparent peelable layer exposed after the temporary substrate is peeled off can be utilized as the surface protection layer. Therefore, in the manufacturing method utilizing the transfer technology, there is no necessity to remove the peeling layer or to form particularly the surface protection layer. As a result, the manufacturing steps can be simplified and a cost reduction can be achieved.

As explained above, in the present invention, the desired organic TFT and the organic EL element can be formed stably on the plastic film with high yield.

### BRIEF DESCRIPTION OF THE DRAWINGS

FIGS. 1A and 1B are sectional views (#1) showing a method of manufacturing a flexible organic EL display according to an embodiment of the present invention;

FIGS. 2A and 2B are sectional views (#2) showing the method of manufacturing the flexible organic EL display according to the embodiment of the present invention;

FIGS. 3A and 3B are sectional views (#3) showing the method of manufacturing the flexible organic EL display according to the embodiment of the present invention;

FIG. 4 is a sectional view (#4) showing the method of manufacturing the flexible organic EL display according to the embodiment of the present invention;

FIG. 5 is a sectional view (#5) showing the method of manufacturing the flexible organic EL display according to the embodiment of the present invention;

FIG. 6 is a sectional view (#6) showing the method of manufacturing the flexible organic EL display according to the embodiment of the present invention;

FIG. 7 is a sectional view (#1) showing the flexible organic EL display according to the embodiment of the present invention;

FIG. 8 is a view showing an equivalent circuit of one pixel portion of the flexible organic EL display according to the embodiment of the present invention;

FIG. 9 is a plan view showing an example of a layout of the pixel portion in the flexible organic EL display according to the embodiment of the present invention;

FIG. 10 is a sectional view (#2) showing the flexible organic EL display according to the embodiment of the present invention;

FIG. 11 is an external view showing an external connection area of the flexible organic EL display according to the embodiment of the present invention;

FIG. 12 is a view showing a sectional state in the longitudinal direction of a gate connection electrode in the external connection area in FIG. 11; and

FIG. 13 is a view showing a sectional state in the longitudinal direction of a source connection electrode in the external connection area in FIG. 11.

### DETAILED DESCRIPTION OF THE PREFERRED EMBODIMENTS

An embodiment of the present invention will be explained with reference to the accompanying drawings hereinafter.

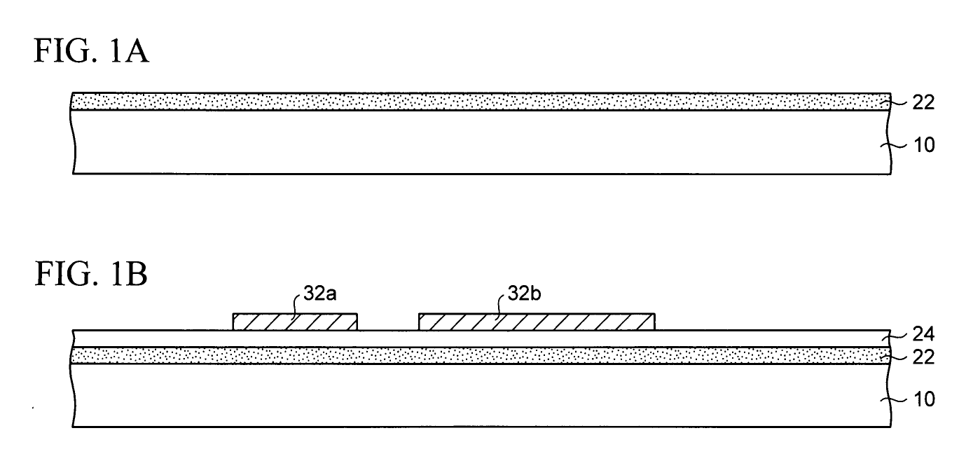

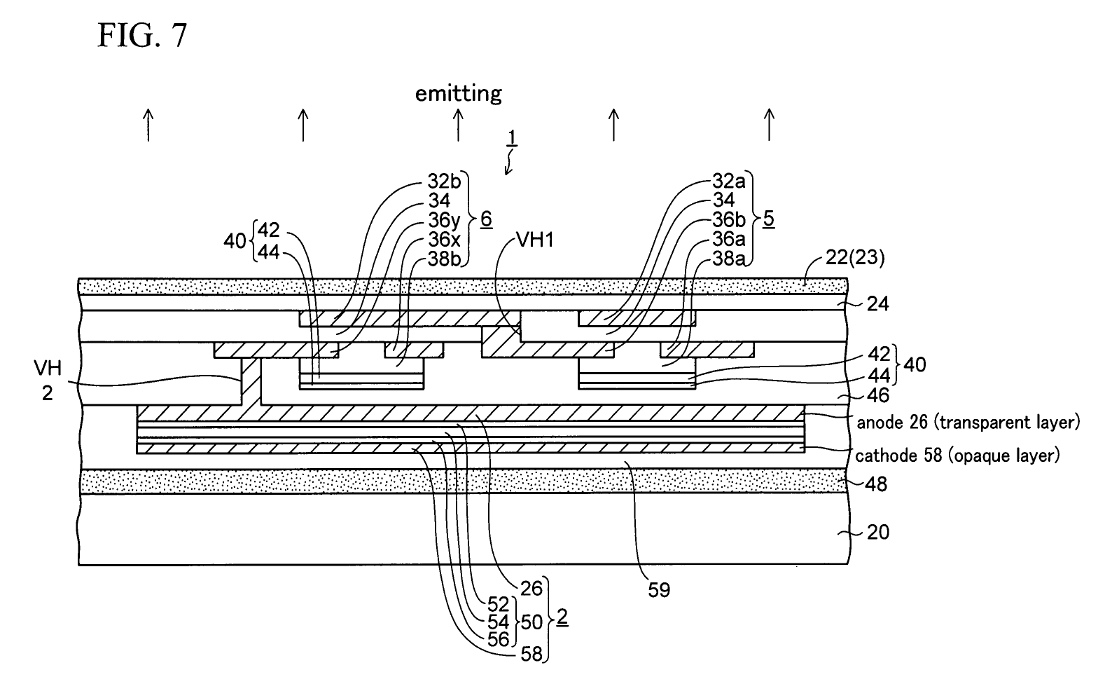

FIGS. 1A and 1B, FIGS. 2A and 2B, FIGS. 3A and 3B, and FIG. 4 to FIG. 6 are sectional views showing a method of manufacturing a flexible organic EL display according to an embodiment of the present invention, and FIG. 7 is a sectional view showing the flexible organic EL display similarly.

In the method of manufacturing the flexible organic EL display according to the present embodiment, as shown in FIG. 1A, first, a glass substrate 10 is prepared as a temporary substrate, and a transparent peelable layer 22 is formed on the glass substrate 10. As described later, the transparent peelable layer 22 functions as a separating layer when the transfer layer formed on the glass substrate 10 is transferred on the plastic film, and also is left on the display, thereby functions as a transparent surface protection layer.

The transparent peelable layer 22 is formed of a polyimide layer that is obtained by condensing tetracarboxylic acid (anhydride) and diamine. As the tetracarboxylic acid (anhydride), benzophenone tetracarboxylic anhydride or pyromellitic acid anhydride is employed. Also, as the diamine, 3,3′-diaminodiphenyl sulfone, 4,4′-diaminodiphenyl sulfone, 3,3′-diaminobenzophenone, or 4,4′-diaminobenzophenone is employed.

Such polyimide layer is transparent until its film thickness is about 5 μm. However, when its film thickness is increased up to a thickness of about 20 μm that functions as a complete film, this polyimide layer is tinged with yellowish. This coloring is caused due to the basicity of amine, and thus this yellow coloring can be weakened by reducing the basicity of amine. That is, when a film thickness of the transparent peelable layer 22 is set thick, this coloring can be weakened by using the diamine that is coupled with substituent having electron-suction property.

In this case, when the coloring does not become an issue, 3,3′-diaminodiphenyl ether, 4,4′-diaminodiphenyl ether, or the like may be employed as the amine.

Then, as shown in FIG. 1B, a buffer layer 24 formed of an inorganic insulating layer such as a silicon oxide layer (SiOₓ), a silicon nitride layer (SiNₓ), or the like is formed on the transparent peelable layer 22. Then, a gate electrode 32a for a switching TFT (Thin Film Transistor) (referred to as a “Sw-TFT” hereinafter) and a gate electrode 32b for a driving TFT (referred to as a “Dr-TFT” hereinafter) are formed on the buffer layer 24.

The gate electrodes 32a, 32b are formed by forming an aluminum (Al) layer, chrome (Cr) layer, a gold (Au) layer, an ITO (Indium Tin Oxide) layer, an IZO (Indium Zinc Oxide) layer, or the like by using the sputter method, or the like, and then patterning the layer by using the photolithography and the etching.

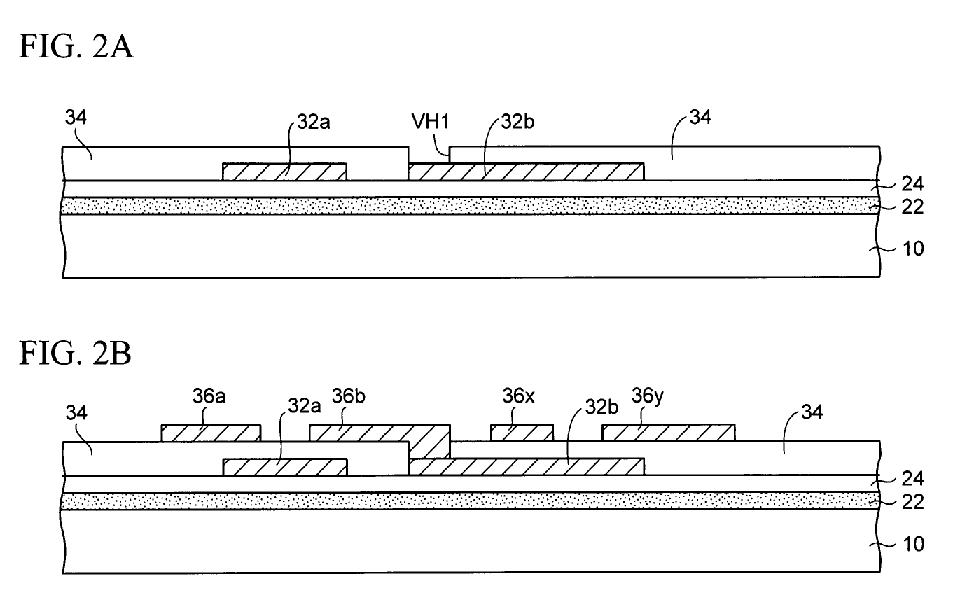

Then, as shown in FIG. 2A, a gate insulating layer 34 is formed on the gate electrodes 32a, 32b. As the preferred example of the method of forming the gate insulating layer 34, such a method is employed that a coating film is formed by coating a coating liquid such as poly vinyl phenol, poly methyl silsesquioxane (organic/inorganic composite material), polyimide, or the like, and then the coating film is heat-treated for about one hour in a temperature atmosphere of 180° C. or more (180 to 250° C.) to cause it to polymerize/cross-link. In this case, the coating material in which polymerization/crosslinking is caused by the ultraviolet irradiation can be also employed.

In the present embodiment, because the flexible display is manufactured by utilizing the transfer technology, the gate insulating layer 34 is formed on the heat-resistant glass substrate 10. Therefore, the coating film can be heat-treated at a desired temperature. As a result, the gate insulating layer 34 not containing a hydroxyl group can be obtained easily from the above coating material.

In the gate insulating layer 34 obtained by such method and not containing a hydroxyl group, dielectric breakdown electric field strength of 1 MV/cm or more can be obtained and a flexible insulating layer which follows a bending stress is constituted. Thus, this flexible insulating layer can be employed preferably as the TFT gate insulating layer of the flexible display.

Otherwise, an inorganic insulating layer such as a silicon oxide layer (SiOₓ), a silicon nitride layer (SiN), a tantalum oxide layer (Ta₂O₅), or the like may be employed as the gate insulating layer 34.

Then, the gate insulating layer 34 is processed by the photolithography and the etching. Thus, a first via hole VH1 reaching the gate electrode 32b of the Dr-TFT is formed.

Then, as shown in FIG. 2B, a source electrode 36a and a drain electrode 36b of the Sw-TFT are formed on the gate insulating layer 34 as a pattern respectively. At the same time, a source electrode 36x and a drain electrode 36y of the Dr-TFT are formed on the gate insulating layer 34 as a pattern respectively. The source electrodes 36a, 36x and the drain electrodes 36b, 36y are arranged such that opposing regions between them (channel regions) overlap with the gate electrodes 32a, 32b respectively.

At this time, the drain electrode 36b of the Sw-TFT is connected electrically to the gate electrode 32b of the Dr-TFT via the first via hole VH1. The source electrodes 36a, 36x and the drain electrodes 36b, 36y are formed by patterning the conductive layer made of the same material as the gate electrodes 32a, 32b by using the photolithography and the etching.

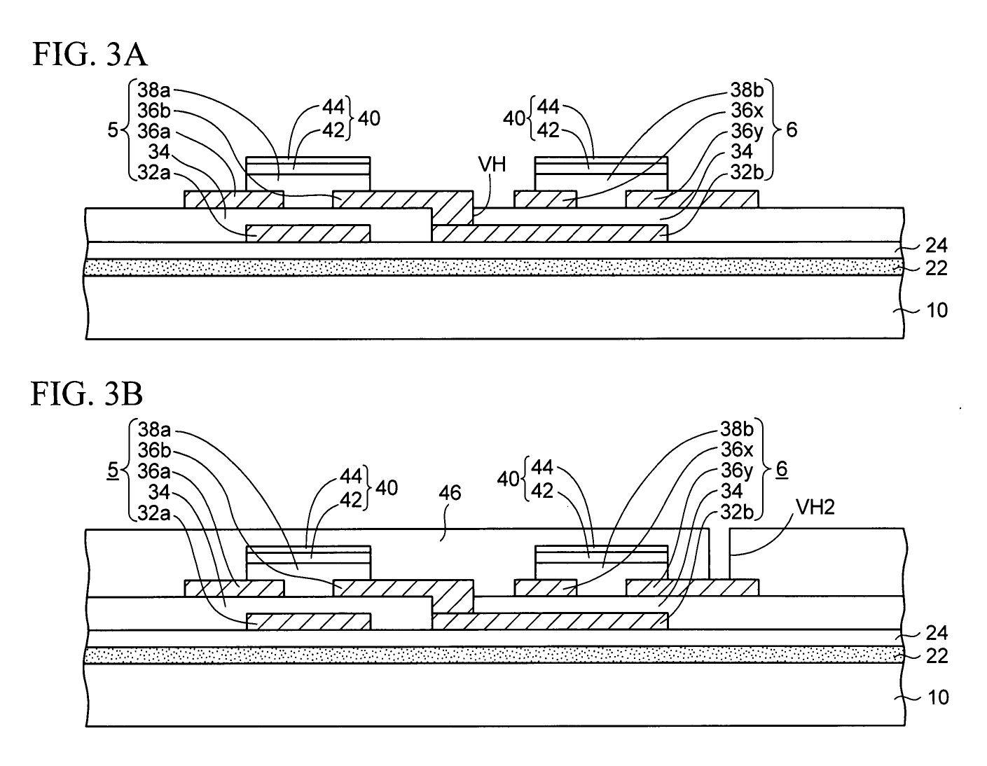

Then, as shown in FIG. 3A, an organic active layer 38a made of an organic semiconductor for the Sw-TFT, and a cap barrier layer 40 composed of a parylene resin layer 42 (polyparaxylylene) and an inorganic insulating layer 44 (SiOₓ, SiNₓ, or the like), are patterned and formed from on the source electrode 36a and the drain electrode 36b of the Sw-TFT to on the gate insulating layer 34 located between them. At the same time, an organic active layer 38b for the Dr-TFT and the cap barrier layer 40 composed of the parylene resin layer 42 and the inorganic insulating layer 44, are patterned and formed from on the source electrode 36x and the drain electrode 36y of the Dr-TFT and to on the gate insulating layer 34 located between them.

The organic active layers 38a, 38b and the cap barrier layer 40 (the parylene resin layer 42/the inorganic insulating layer 44) are formed by forming an organic active layer, a parylene resin layer, and an inorganic insulating layer like a blanket by using the vacuum deposition method, or the like, and then patterning these layers by using the photolithography and the etching.

A film thickness of the organic active layers 38a, 38b is set to about 50 nm, for example. As the material, pentacene, sexithiophene, polythiophene, or the like is preferably employed. In the present embodiment, the organic active layers 38a, 38b are formed of a p-type semiconductor respectively.

The organic active layers 38a, 38b are covered with the cap barrier layer 40 (the parylene resin layer 42 and the inorganic insulating layer 44) respectively. Therefore, the degradation of performance caused by the wet process in the photolithography step, the plasma, or the like can be prevented.

Accordingly, a Sw-TFT 5 composed of the gate electrode 32a, the gate insulating layer 34, the source electrode 36a, the drain electrode 36b, and organic active layer 38a connected electrically to the source electrode 36a and the drain electrode 36b, is obtained. Also, a Dr-TFT 6 composed of the gate electrode 32b, the gate insulating layer 34, the source electrode 36x, the drain electrode 36y, and organic active layer 38b connected electrically to the source electrode 36x and the drain electrode 36y, is obtained. Then, the drain electrode 36b of the Sw-TFT 5 is connected electrically to the gate electrode 32b of the Dr-TFT 6 via the first via hole VH.

Then, as shown in FIG. 3B, a first protection insulating layer 46 is formed on the Sw-TFT 5 and the Dr-TFT 6 to cover them. As the first protection insulating layer 46, a stacked film composed of an organic insulating film such as the parylene layer, and an inorganic insulating film such as a silicon oxide layer (SiOₓ), a silicon nitride layer (SiNₓ), or the like, which is capable of blocking the entering of a steam or a gas, is preferably employed.

This first protection insulating layer 46 is formed by the CVD method or the vacuum deposition method.

Then, the first protection insulating layer 46 is processed by the photolithography and the etching. Thus, a second via hole VH2 reaching the drain electrode 36y of the Dr-TFT 6 is formed.

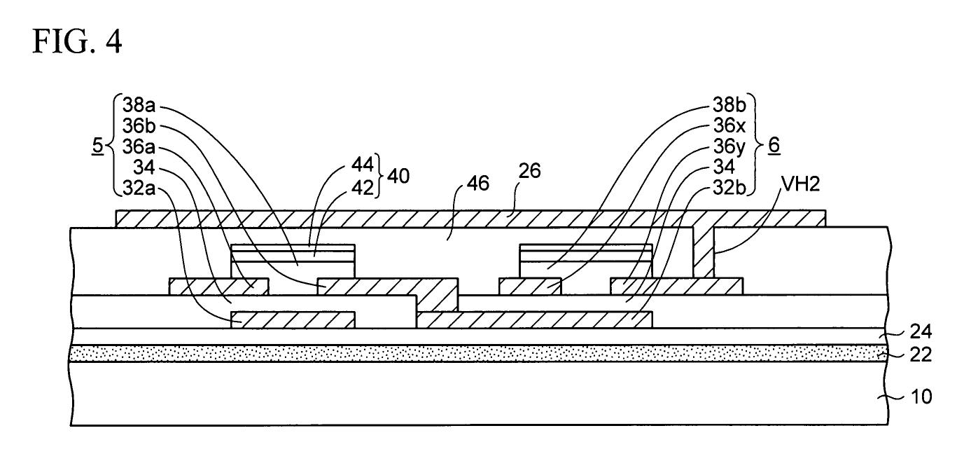

Then, as shown in FIG. 4, an anode 26 connected electrically to the drain electrode 36y of the Dr-TFT 6 via the second via hole VH2 is patterned and formed on the first protection insulating layer 46. This anode 26 may be formed of a transparent conductive layer such as an ITO (Indium Tin Oxide) layer, an IZO (Indium Zinc Oxide) layer, or the like. Otherwise, the anode 26 may be formed of an opaque conductive layer such as a gold (Au) layer, a platinum (Pt) layer, a silver (Ag) layer, or the like.

The anode 26 is formed by patterning a conductive layer, which is formed by the sputter method, by using the photolithography and the etching.

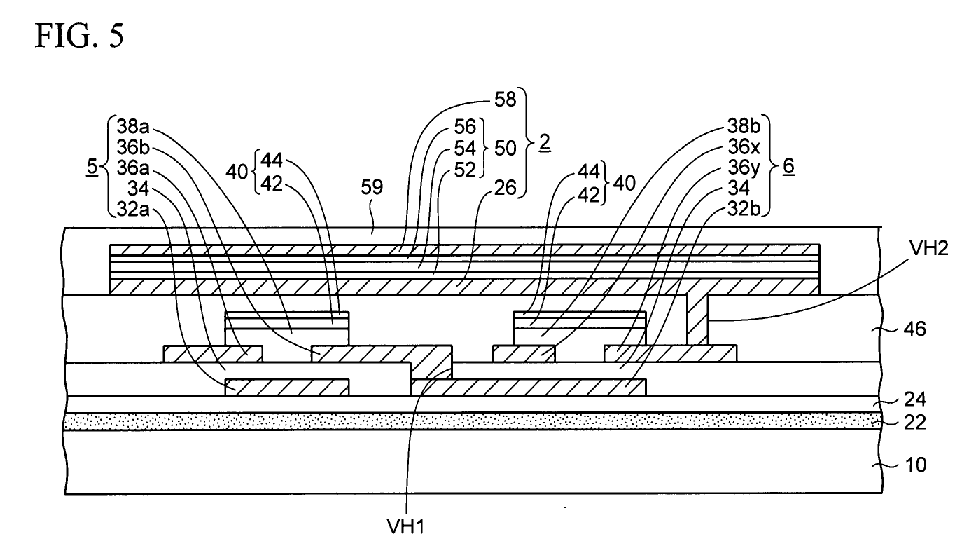

Then, as shown in FIG. 5, a hole transporting layer 52 is formed selectively on the anode 26 by the mask deposition method, or the like. As the hole transporting layer 52, α-NPD as an aromatic tertiary amine derivative, or the like is employed preferably. Then, as also shown in FIG. 5, a light emitting layer 54 of low polymer-series whose film thickness is 70 nm, for example, is formed selectively on the hole transporting layer 52 by the mask deposition method, or the like.

As the light emitting layer 54 of low polymer-series, the material in which the doping material is mixed into the host material is employed, and the doping material (molecules) emits a light. As the host material, there are Alq3 and a distyrylarylene derivative (DPVBi), for example, while as the doping material, there are a coumalin 6 for the emission of green light and DCJTB for the emission of red light, for example.

When a full color display is implemented by respective light emitting layers 54 for the three primary colors, a red light emitting layer, a green light emitting layer, and a blue light emitting layer are formed on the hole transporting layers 52 of the pixel portions (not shown) for three primary colors (red (R), green (G), and blue (B)) respectively. Otherwise, when a white light emitting layer is employed as the light emitting layer 54, the full color display can be implemented by combining the white light emitting layer with color filters.

Then, as shown in FIG. 5 similarly, an electron transporting layer 56 is formed selectively on the light emitting layer 54 by the mask deposition method. As the electron transporting layer 56, a quinolinol aluminum complex (Alq3), or the like is employed preferably.

Otherwise, the hole transporting layer 52, the light emitting layer 54, and the electron transporting layer 56 are formed by the ink jet system as a pattern respectively.

Accordingly, an organic EL layer 50 composed of the hole transporting layer 52, the light emitting layer 54, and the electron transporting layer 56 is obtained.

In this case, a mode in which only either of the hole transporting layer 52 and the electron transporting layer 56 is formed may be employed, or a mode in which both the hole transporting layer 52 and the electron transporting layer 56 are omitted may be employed.

Then, as also shown in FIG. 5, a cathode 58 opposing to the anode 26 is formed selectively on the electron transporting layer 56 by the mask deposition method. As the cathode 58, a transparent conductive layer may be employed, or an opaque conductive layer such as a lithium fluoride/aluminum (LiF/Al) stacked film, or the like may be employed.

As described later, the anode 26 and the cathode 58 are composed as a combination in which one is the transparent conductive layer and the other is the opaque conductive layer. A combination of the transparent and opaque in them is selected depending on whether the light emitted from the organic EL layer 50 is passed through the anode 26 or the cathode 58.

Accordingly, an organic EL element 2 composed of the anode 26, the organic EL layer 50, and the cathode 58 is obtained.

Then, as also shown in FIG. 5, a second protection insulating layer 59 is formed on the organic EL element 2 to cover it. As the second protection insulating layer 59, like the foregoing first protection insulating layer 46, the stacked film composed of the organic insulating layer (the parylene layer, or the like) and the inorganic insulating layer is employed preferably.

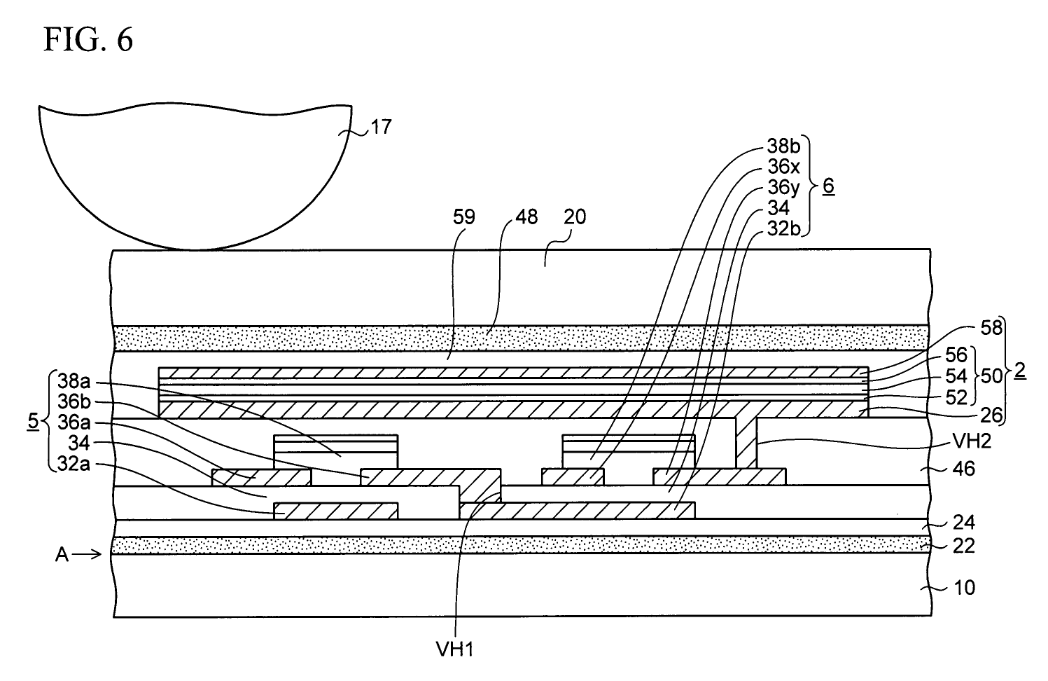

Then, as shown in FIG. 6, a plastic film 20 is arranged on an upper surface of the second protection insulating layer 59 to oppose to the second protection insulating layer 59 via the adhesive layer 48. Then, the adhesive layer 48 is cured by the heat treatment, and thus the plastic film 20 is adhered onto the structure in FIG. 5. As the plastic film 20, a polyether sulfone film, a polycarbonate film, or the like, which has a film thickness of 100 to 200 μm, is employed preferably.

Then, as also shown in FIG. 6, a roller 17 is fixed to one end of the plastic film 20, and then the glass substrate 10 is peeled while causing the roller 17 to rotate. At this time, the glass substrate 10 is peeled along a boundary between the transparent peelable layer 22 and the glass substrate 10 (A portion in FIG. 6). Then, the glass substrate 10 is disposed.

In FIG. 7, such a state is shown that the glass substrate 10 is removed from the structure in FIG. 6 and then the top and bottom of the resultant structure is reversed. As shown in FIG. 7, the adhesive layer 48, the second protection insulating layer 59, the organic EL element 2, the first protection insulating layer 46, the Sw-TFT 5 and the Dr-TFT 6 under which the cap barrier layer 40 is provided respectively, the buffer layer 24, and the transparent peelable layer 22 are transferred/formed in sequence from the bottom on the plastic film 20. The transparent peelable layer 22 exposed on the uppermost surface is left as a surface protection layer 23.

With the above, a flexible organic EL display 1 of the present embodiment is obtained.

As shown in FIG. 7, the flexible organic EL display 1 of the present embodiment, an adhesive layer 48 and the second protection insulating layer 59 (lower insulating layer) are formed sequentially on the plastic film 20. The organic EL element 2 is embedded in the second protection insulating layer 59. In the present embodiment, since the foregoing transfer technology is employed, the organic EL element 2 formed on the glass substrate 10 is arranged in a state that the top and bottom reverses.

The organic EL element 2 is constructed by stacking the cathode 58, the organic EL layer 50, and the anode 26 sequentially from the bottom. The organic EL layer 50 is constructed by stacking the electron transporting layer 56, the light emitting layer 54, and the hole transporting layer 52 sequentially from the bottom. Then, the organic EL element 2 is embedded in the second protection insulating layer 59 such that an upper surface of the anode 26 and an upper surface of the second protection insulating layer 59 constitute the identical surface.

Also, the first protection insulating layer 46 (upper insulating layer) is formed on the organic EL element 2. The Sw-TFT 5 and the Dr-TFT 6 are embedded side by side in the lateral direction in the first protection insulating layer 46. Like the organic EL element 2, the Sw-TFT 5 and the Dr-TFT 6 formed on the glass substrate 10 are arranged in a state that the top and bottom reverses.

The Sw-TFT 5 is constructed by forming the organic active layer 38a, the source electrode 36a and the drain electrode 36b, the gate insulating layer 34, and the gate electrode 32a sequentially from the bottom. Similarly, the Dr-TFT 6 is constructed by forming the organic active layer 38b, the source electrode 36x and the drain electrode 36y, the gate insulating layer 34, and the gate electrode 32b sequentially from the bottom.

The respective source electrodes 36a, 36x and the respective drain electrodes 36b, 36y are arranged to extend from the inner areas of the gate electrodes 32a, 32b to the outer side. The organic active layers 38a, 38b arranged in the opposing areas located between them constitute the channel portions of respective TFTs.

The cap barrier layer 40 composed of the parylene resin layer 42 and the inorganic insulating layer 44 is formed in the under surface of the respective organic active layers 38a, 38b of the Sw-TFT 5 and the Dr-TFT 6 respectively.

Also, the buffer layer 24 and the transparent peelable layer 22 are formed in order on the Sw-TFT 5 and the Dr-TFT 6. The transparent peelable layer 22 functions as the surface protection layer 23.

In the method of manufacturing the flexible organic EL display of the present embodiment, on the glass substrate 10, the organic TFT (the Sw-TFT 5 and the Dr-TFT 6) is formed between the buffer layer 24 and the first protection insulating layer 46, the organic EL element 2 is formed between the first protection insulating layer 46 and the second protection insulating layer 59, and these elements are transferred onto the plastic film 20.

By employing such approach, the organic EL element 2 is formed under the organic TFT (the Sw-TFT 5 and the Dr-TFT 6) such that this element is protected with the first and second protection insulating layers 46, 59 and embedded therein. As a result, such a situation can be prevented that steam from an outside air and moisture in the plastic film 20 enter into the organic EL element 2, and thus reliability of the organic EL element 2 can be improved.

Also, the organic active layers 38a, 38b are arranged between the buffer layer 24 and the first protection insulating layer 46. Therefore, such a situation can be prevented that steam from an outside air and moisture in the plastic film 20 enter into the organic active layers 38a, 38b, and thus reliability of the organic TFT can be improved.

Also, as content should be mentioned specially, the organic EL element 2 is protected with the multi-layered gas barrier layer composed of the buffer layer 24, the gate insulating layer 34, and the first protection insulating layer 46, which is provided to the surface on the TFTs 5, 6 side, thereby higher reliability can be obtained.

Also, in the step of forming the organic active layers 38a, 38b, the organic active layers 38a, 38b are protected with the cap barrier layer 40. Therefore, there is no fear that performance of the organic active layers 38a, 38b is degraded even when the photolithography is applied. Also, the organic EL layer 50 is formed without the application of the photolithography. Therefore, degradation of performance of the organic EL layer 50 is not caused.

Further, in the present embodiment, since the transfer technology is utilized, in the formation of the gate insulating layer 34, the insulating layer not containing the hydroxyl group can be formed by heat-treating the coating film such as poly(vinyl phenol), or the like at a temperature of 180° C. or more on the glass substrate 10. Therefore, the gate insulating layer 34 that has a sufficient dielectric breakdown electric field strength (1 MV/cm or more) and can follow a bending stress can be transferred/formed on the plastic film 20.

Also, the transparent peelable layer 22 is used as the separating layer at a time of the transfer operation. Thus, the transparent peelable layer 22 exposed after the glass substrate 10 is peeled off can be utilized as the surface protection layer 23. Therefore, in the manufacturing method utilizing the transfer technology, there is no necessity to remove the peeling layer or to form particularly the surface protection layer. As a result, the manufacturing steps can be simplified and a cost reduction can be achieved.

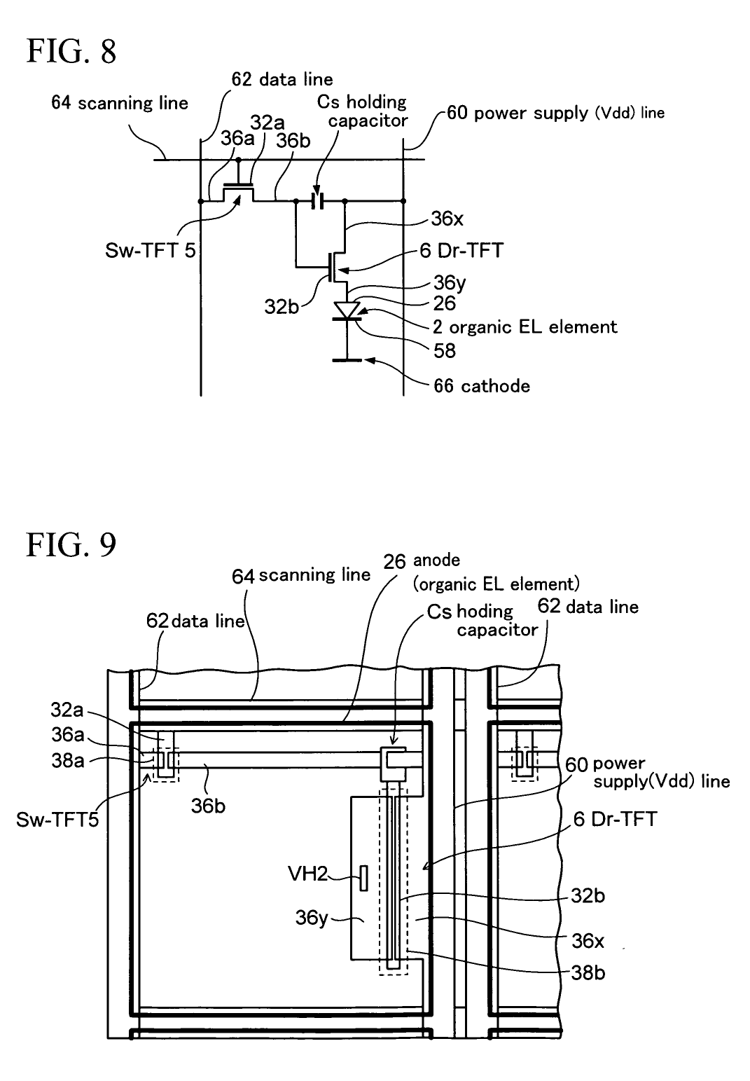

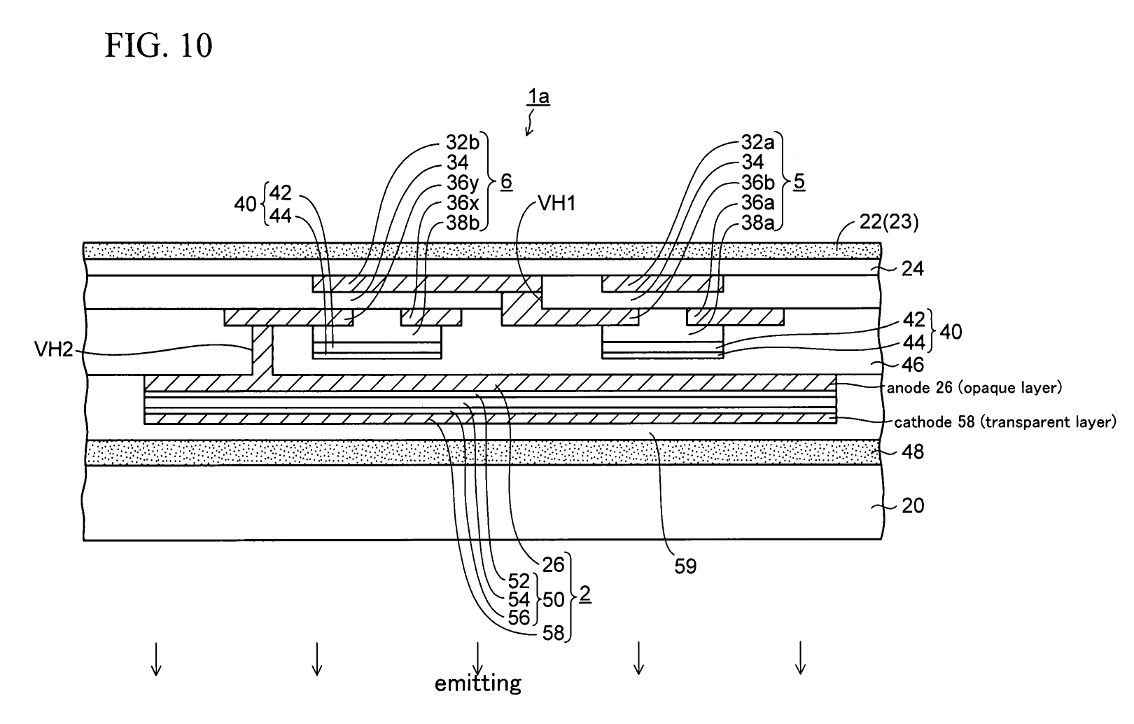

FIG. 8 is a view showing an equivalent circuit of one pixel portion of the flexible organic EL display according to the embodiment of the present invention, and FIG. 9 is a plan view showing an example of a layout of the pixel portion in the flexible organic EL display according to the embodiment of the present invention.

An equivalent circuit in FIG. 8 will be explained while referring to appropriately a plan view in FIG. 9 hereunder. The cathode 58 of the organic EL element 2 is connected to a cathode 66, and the anode 26 of the organic EL element 2 is connected to the drain electrode 36y of the Dr-TFT 6 via the via hole VH2. The source electrode 36x of the Dr-TFT 6 is connected to a power supply (Vdd) line 60.

Also, a holding capacitor Cs is formed between the gate electrode 32b of the Dr-TFT 6 and the power supply (Vdd) line 60. Also, the drain electrode 36b of the Sw-TFT 5 is connected to the gate electrode 32b of the Dr-TFT 6, and the source electrode 36a of the Sw-TFT 5 is connected to a data line 62. Further, the gate electrode 32a of the Sw-TFT 5 is connected to a scanning line 64.

The equivalent circuit in FIG. 8 operates as follows. First, when a potential of the scanning line 64 is set to a selection state and then a writing potential is applied to the scanning line 64, the Sw-TFT 5 becomes conductive state and the holding capacitor Cs is charged or discharged, and then a gate potential of the Dr-TFT 6 is set to a writing potential. Then, when a potential of the scanning line 64 is set to a non-selection state, the Dr-TFT 6 is disconnected electrically from the scanning line 64, but a gate potential of the Dr-TFT 6 is held stably by the holding capacitor Cs.

Then, a current flowing to the Dr-TFT 6 and the organic EL element 2 has a value that responds to a gate-source voltage of the Dr-TFT 6. Thus, the organic EL element 2 continues to emit a light at a luminance that responds to the current value.

A pixel having such constitutions are aligned plurally in a matrix fashion and the writing is repeated through the data line 62 while sequentially selecting the scanning line 64, thereby an active-matrix type organic EL display can be composed. In this manner, the light is emitted from the light emitting layers 54 of respective pixel portions to the outside, and the image can be obtained.

The flexible organic EL display 1 in FIG. 7 shows such a mode that the anode 26 is formed of the transparent layer and the cathode 58 is formed of the opaque layer. In this case, the light emitted from the light emitting layer 54 is passed through the anode 26 and is emitted to the outside (an arrow direction in FIG. 7). That is, the light is not passed through the plastic film 20 and is emitted to the opposite side.

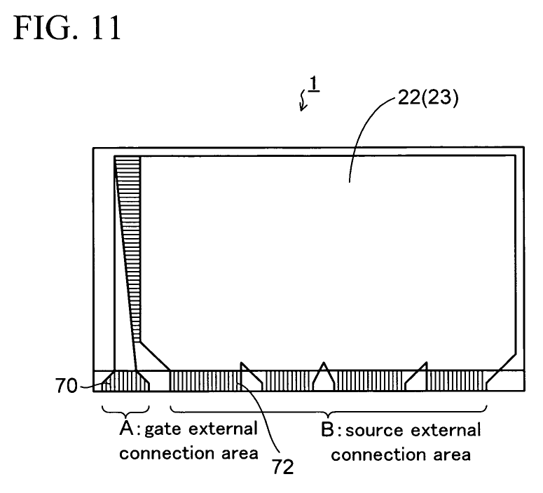

In FIG. 10, a flexible organic EL display lain which the anode 26 is formed of the opaque layer and the cathode 58 is formed of the transparent layer, on the contrary to FIG. 7, is shown. In this case, the light emitted from the light emitting layer 54 is passed through the cathode 58 and is emitted to the outside (an arrow direction in FIG. 10). That is, the light is passed through the plastic film 20 and is emitted to the outside.

In particular, in the flexible organic EL display 1a in FIG. 10, the light is emitted to the opposite side to the TFTs 5, 6 (the plastic film 20 side). Therefore, a high aperture ratio can be obtained even when the TFTs 5, 6 are formed of the opaque layer. Also, since the TFTs 5, 6 are arranged to overlap with the anode 26, a high aperture ratio can be obtained from such a viewpoint that an area of the anode 26 can be increased.

In FIG. 10, respective constituent elements are similar to those in FIG. 7, and therefore their explanation will be omitted herein by affixing the same reference symbols.

In this manner, in the flexible organic EL displays 1, 1a of the present embodiment, the light can be emitted from the plastic film 20 side or the opposite side to the plastic film 20, by controlling the transparent/opaque combination between the anode 26 and the cathode 58.

Next, an external connection area of the flexible organic EL display of the present embodiment will be explained hereunder. FIG. 11 is a plan view showing an external connection area of the flexible organic EL display according to the embodiment of the present invention. As shown in FIG. 11, a gate external connection area A and a source external connection area B are provided to one end side of the flexible organic EL display 1.

In the gate external connection area A, a large number of gate connection electrodes 70 connected to the scanning line (64 in FIG. 8) connected to the gate electrodes 32a of the Sw-TFTs 5 are arranged side by side. Also, in the source external connection area B, a large number of source connection electrodes 72 connected to the data line (62 in FIG. 8) connected to the source electrodes 36a of the Sw-TFTs 5 are arranged side by side.

The transparent peelable layer 22 is left in the main portion of the flexible organic EL displays 1 as the surface protection layer 23. But the stacked films containing the surface protection layer 23 are removed collectively in the gate external connection area A and the source external connection area B, and the gate connection electrode 70 and the source connection electrode 72 are exposed.

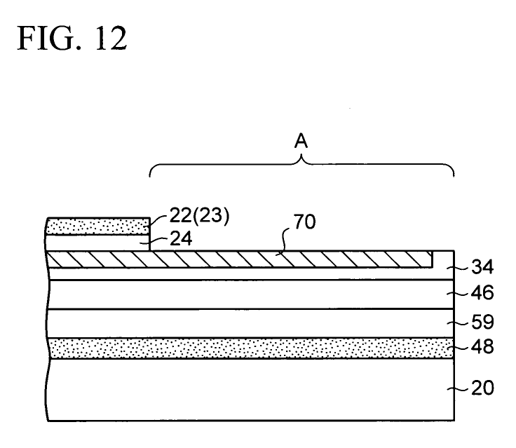

That is, by reference to FIG. 12 (a sectional view of the longitudinal direction of the gate connection electrode 70 in FIG. 11) in addition, the transparent peelable layer 22 and the buffer layer 24 under it are removed in the gate external connection area A, and a plurality of gate connection electrodes 70 are exposed.

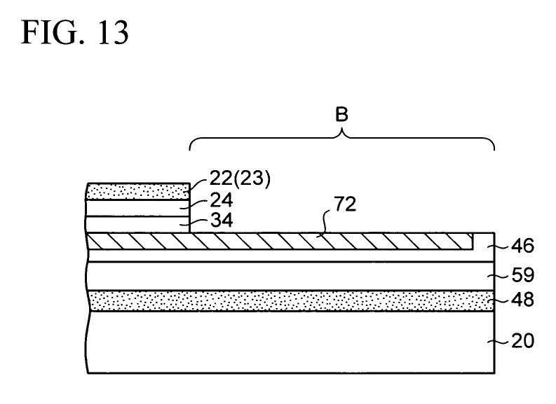

Also, by reference to FIG. 13 (a sectional view of the longitudinal direction of the source connection electrode 72 in FIG. 11) in addition, in the source external connection area B, the transparent peelable layer 22, the buffer layer 24 and the gate insulating layer 34 under it are removed, and a plurality of source connection electrodes 72 are exposed. The gate connection electrodes 70 and the source connection electrodes 72 are connected electrically to the external circuit substrate, or the like.

In order to expose the gate connection electrodes 70 and the source connection electrodes 72, a mask for protecting the display area but exposing collectively the external connection areas A, B may be arranged, and then the stacked film containing the surface protection layer 23 may be etched via the mask by the plasma etching, or the like.

What is claimed is:

1. A flexible organic EL display of active matrix type in which a TFT and an organic EL element are provided in every pixel, comprising:
a plastic film;
an adhesive layer formed on the plastic film;
a lower insulating layer formed on the adhesive layer;
the organic EL element embedded in the lower insulating layer and constructed by forming a cathode, an organic EL layer, and an anode sequentially from a bottom;
an upper insulating layer formed on the organic EL element;
the TFT embedded in the upper insulating layer, and constructed by forming an organic active layer, a source electrode and a drain electrode, a gate insulating layer, and a gate electrode sequentially from a bottom; and
a via hole provided in the upper insulating layer and reaching the drain electrode of the TFT;
wherein the anode is connected electrically to the drain electrode of the TFT via the via hole.

2. A flexible organic EL display according to claim 1, further comprising:
a buffer layer formed on the TFT and made of an inorganic insulating layer; and
a surface protection layer formed on the buffer layer and made of transparent polyimide.

3. A flexible organic EL display according to claim 1, wherein the gate insulating layer of the TFT is formed of an insulating layer that contains no hydroxyl group and is obtained by polymerizing/cross-linking poly vinyl phenol, poly methyl silsesquioxane, or polyimide by applying a heat treatment.

4. A flexible organic EL display according to claim 2, wherein an external connection area in which a gate connection electrode connected electrically to the gate electrode of the TFT and a source connection electrode connected electrically to the source electrode of the TFT are arranged respectively is provided in an end side of the flexible organic EL display, and a stacked film containing the surface protection layer is removed in the external connection area, and the gate connection electrode and the source connection electrode are exposed.

5. A flexible organic EL display according to claim 1, wherein the TFT is composed of a switching TFT and a driving TFT connected to the switching TFT, and the drain electrode of the driving TFT is connected to the anode, and
a via hole reaching the gate electrode of the driving TFT is provided in the gate insulating layer, and the drain electrode of the switching TFT is connected electrically to the gate electrode of the driving TFT via the via hole.

6. A flexible organic EL display according to claim 1, wherein the organic EL layer is composed of
a light emitting layer, and
at least one of a hole transporting layer formed between the anode and the light emitting layer, and an electron transporting layer formed between the light emitting layer and the cathode.

7. A method of manufacturing a flexible organic EL display of active matrix type in which a TFT and an organic EL element are provided in every pixel, comprising the steps of:
forming a transparent peelable layer on a temporary substrate;
forming the TFT constructed by forming a gate electrode, a gate insulating layer, a source electrode and a drain electrode, and an organic active layer over the transparent peelable layer sequentially from a bottom;
forming a first insulating layer on the TFT;
forming a via hole reaching the drain electrode of the TFT, by processing the first insulating layer;
forming the organic EL element composed of an anode connected to the drain electrode via the via hole, an organic EL layer formed on the anode, and a cathode formed on the organic EL layer, on the first insulating layer;
forming a second insulating layer on the organic EL element;
adhering a plastic film onto the second insulating layer via an adhesive layer; and
transferring/forming the second insulating layer, the organic EL element, the first insulating layer, the TFT, and the transparent peelable layer onto the plastic film via the adhesive layer, by peeling the temporary substrate along a boundary between the temporary substrate and the transparent peelable layer.

8. A method of manufacturing a flexible organic EL display according to claim 7, wherein after the step of forming the transparent peelable layer, further comprising:
a step of forming a buffer layer made of an inorganic insulating layer on the transparent peelable layer.

9. A method of manufacturing a flexible organic EL display according to claim 7, wherein after the step of transferring/forming onto the plastic film, the transparent peelable layer is left as a surface protecting layer.

10. A method of manufacturing a flexible organic EL display according to claim 7, wherein, in the step of forming the TFT, the gate insulating layer is formed of an insulating layer that contains no hydroxyl group and is obtained by polymerizing/cross-linking poly vinyl phenol, poly methyl silsesquioxane, or polyimide by applying a heat treatment.

11. A method of manufacturing a flexible organic EL display according to claim 7, wherein an external connection area in which a gate connection electrode connected electrically to the gate electrode of the TFT and a source connection electrode connected electrically to the source electrode of the TFT are arranged respectively is provided in an end side of the flexible organic EL display, and
after the step of transferring/forming onto the plastic film, the gate connection electrode and the source connection electrode are exposed by removing a stacked film containing the surface protection layer in the external connection area.
